(19) United States
(12) Patent Application Publication
(10) Pub. No.: US 2001/0040092 A1
(43) Pub. Date: Nov. 15, 2001

(54) Gas sensor

(76) Inventors: Takanori Yanagisawa, Chiryu-shi (JP); Nobuyuki Tsuji, Okazaki-shi (JP); Masanori Fukutani, Nagoya (JP); Takao Mishima, Aichi-ken (JP)

Correspondence Address: Pillsbury Madison & Sutro LLP, Intellectual Property Group, Ninth Floor, East Tower, 1100 New York Avenue, N.W., Washington, DC, 20005-3918, US

(21) Appl. No.: 09/853,786

(22) Filed: May 14, 2001

(30) Foreign Application Priority Data
May 12, 2000 (JP) 2000-140214
Mar. 30, 2001 (JP) 2001-100668

(51) Int. Cl. G01N 27/407

(52) U.S. Cl. 204/427; 204/428

(57) ABSTRACT

A sensing element has a cup-shaped solid electrolytic body with one end closed and an inside space serving as a reference gas chamber, a sensing electrode provided on an outer surface of the solid electrolytic body so as to be exposed to measured gas, and a reference electrode provided on an inner surface of the solid electrolytic body so as to be exposed to reference gas in the reference gas chamber. A heater is disposed in the reference gas chamber. The solid electrolytic body has a leg consisting of a proximal portion and a distal portion. The distal portion is thinner than the proximal portion. And, the heater is brought into contact with a surface defining the reference gas chamber at least partly in the region of the distal portion.

### BACKGROUND OF THE INVENTION

The present invention relates to a heater-equipped gas sensor which is preferably installed in an internal combustion engine to detect the concentration of a specific gas, such as oxygen, involved in the exhaust gas and to control an air-fuel ratio of the internal combustion engine.

To control the air-fuel ratio, internal combustion engines are generally equipped with oxygen sensors provided in their exhaust passages.

For example, a conventional oxygen sensor comprises a cup-shaped solid electrolytic body having an inside space serving as a reference gas chamber (i.e., air chamber), a sensing electrode provided on an outer surface of the solid electrolytic body so as to be exposed to a measured gas, and a reference electrode provided on an inner surface of the solid electrolytic body. The sensing electrode and the reference electrode extend entirely or partly on the outer and inner surfaces of the solid electrolytic body. Furthermore, an electric heater is disposed in the reference chamber.

This kind of oxygen sensor does not operate properly until its temperature reaches a predetermined higher level (referred to as active temperature). The heater is equipped to quickly increase the temperature of the oxygen sensing element when the engine is in a cold condition, thereby shortening a sensor deactivated or dormant period to correctly measure the oxygen concentration as quickly as possible in an engine startup operation.

The oxygen sensing element, when it cannot accurately detect the oxygen concentration, will worsen the air-fuel ratio control of the engine and deteriorate the effect of purifying poisonous or contaminated emission contained in the exhaust gas.

In view of recent severe requirements and law regulations for reducing or suppressing poisonous or contaminated emission contained in the exhaust gas, it is earnestly requested to warm up the sensing element as quickly as possible. As one of prospective methods, it is preferable to reduce the thickness of a distal (or front) end of the sensing element so as to reduce the heat mass. The sensing element can be quickly warmed up by the heater.

However, solely reducing the thickness of the sensing element will raise the following problem.

The temperature gradient in the axial direction of the sensing element becomes large. It becomes difficult to obtain an accurate sensor output.

More specifically, a temperature difference between the distal end of the sensing element and a proximal end of the sensing element becomes so large that the sensor output is significantly influenced by temperature gradient. Namely, when the distal end of the sensing element is chiefly heated, temperature of the proximal end will not so increase. The sensor output will be adversely influenced by the delay or lack of temperature increase at the proximal end. Prompt activation of the sensing element cannot be realized.

### SUMMARY OF THE INVENTION

In view of the above conventional problem, the present invention has an object to provide a gas sensor which can realize prompt activation of a sensing element.

To accomplish this and other related objects, the present invention provides a gas sensor comprising a cup-shaped solid electrolytic body with one end closed and an inside space serving as a reference gas chamber, a sensing electrode provided on an outer surface of the solid electrolytic body so as to be exposed to measured gas, a reference electrode provided on an inner surface of the solid electrolytic body so as to be exposed to reference gas in the reference gas chamber, and a heater disposed in the reference gas chamber. The solid electrolytic body has a leg to be disposed in the measured gas. The leg comprises a proximal portion and a distal portion. The distal portion is thinner than the proximal portion. And, the heater is brought into contact with a surface defining the reference gas chamber at least partly in the region of the distal portion.

The characteristic features of the present invention reside in that the solid electrolytic body has a leg to be disposed in the measured gas. The leg comprises the proximal portion and the distal portion. The distal portion is thinner than the proximal portion. Furthermore, the heater is brought into contact with a surface defining the reference gas chamber at least partly in the region of the distal portion. For example, the heater is directly brought into contact with the inner surface of the solid electrolytic body or indirectly brought into contact with the solid electrolytic body via the reference electrode. As described later, it is preferable to provide a heat absorbing layer on the reference electrode. In this case, the heater is indirectly brought into contact with the solid electrolytic body via the heat absorbing layer and the reference electrode. In short, at least part of the heater contacts in a solid-to-solid relationship with the sensing element.

The gas sensor of the present invention functions in the following manner.

Reducing the thickness of the distal portion makes it possible to suppress heat transfer to the proximal portion, thereby effectively reducing leakage of heat from the sensing element.

Furthermore, reducing the thickness of the distal portion makes it possible to reduce the heat capacity of the sensing element. The heater can effectively warm up the sensing element.

Furthermore, the heater is brought into contact with the solid electrolytic body within a region corresponding to the distal portion. Heat generated from the heater is directly transmitted in a solid-to-solid relationship to the sensing element.

Thus, the present invention provides a gas sensor capable of realizing prompt activation of the sensing element.

It is preferable that the distal portion of the leg is formed into a straight shape with a constant diameter of the solid electrolytic body (refer to FIG. 3).

Alternatively, it is preferable to form the distal portion of the leg into a slightly tapered shape with a diameter gradually reducing as it approaches a tip end thereof (refer to FIG. 7B).

Furthermore, according to the present invention, it is preferable that a length N and a thickness t of the distal portion of the leg satisfy the relationship N≧5 mm and t≦0.7 mm.

This arrangement effectively reduces leakage of heat from the distal portion to the proximal portion and also reduces the heat capacity of the sensing element, thereby realizing a gas sensor having a short activation time.

If the length N of the distal portion is shorter than 5 mm, a relatively large amount of heat will leak to the thicker proximal portion. The activation time will not be shortened so much.

In view of machining or working properties, a preferable upper limit of the length N of the distal portion is 20 mm.

If the thickness t of the distal portion is larger than 0.7 mm, the heat capacity of the sensing element becomes so large that effect of shortening the activation time is substantially canceled.

In view of machining or working properties, a preferable lower limit of the thickness t of the distal portion is 0.4 mm.

According to this invention, the length N is defined as a distance from a starting point positioned at a boundary between the proximal portion and the distal portion to an eng point positioned at a tip of the sensing element (refer to FIG. 3). The thickness t is defined by a thickness of the solid electrolytic body in the straight region of the distal portion, as shown in FIG. 3.

Furthermore, according to the present invention, it is preferable that a length L and a thickness T of the leg satisfy the relationship L/T≦25 and L≧20 mm.

This arrangement is effective to shorten the activation time.

If the ratio L/T is larger than 25, not only shock resistance but workability will be worsened. A preferable lower limit of L/T is 5.

If the ratio L/T is smaller than 5, a thickness difference between the distal portion and the proximal portion becomes so large that effect of shortening the activation time is substantially canceled.

When the length L is smaller than 20 mm, the oxygen concentration cannot be accurately detected due to shortage in length of the leg to be exposed to the measured gas.

A preferable upper limit of the length L is 40 mm. If the length L is larger than 40 mm, machining or working properties will be worsened.

The length L of the leg is defined by a distance from a starting point positioned beneath a flange of the sensing element to the tip of the sensing element (refer to FIG. 3). In other words, the length L represents a region to be exposed to the measured gas when the gas sensor is installed in an exhaust pipe.

The thickness T is defined by a thickness of the solid electrolytic body beneath the flange of the sensing element.

Furthermore, according to the present invention, it is preferable that the heater has a heat generating distribution having a peak temperature within a region corresponding to the distal region.

This arrangement is effective to effectively warm up the distal portion of the sensing element, thereby greatly shortening the activation time.

Furthermore, according to the present invention, it is preferable that a protective layer is provided to cover an outer surface of the sensing electrode, and a thickness of the protective layer is not larger than 300 μm.

This arrangement provides a thin protective layer which can effectively reduce the heat capacity of the sensing element.

If the thickness of the protective layer exceeds 300 μm, effect of shortening the activation time may be weakened. In view of the durability to poisonous substances, a preferable lower limit of the thickness of the protective layer is 50 μm.

Furthermore, according to the present invention, it is preferable that a heat absorbing layer is provided as a wall of the reference gas chamber at least partly in a region corresponding to the distal portion.

This is effective to realize prompt activation. For example, the heat absorbing layer is directly provided on the inner surface of the solid electrolytic body. Alternatively, the heat absorbing layer is provided on the reference electrode.

The heat absorbing layer preferably comprises at least one component selected from the group consisting of alumina, titanium oxide, zirconium dioxide, iron oxide, nickel oxide, manganous oxide, copper oxide, cobalt oxide, chrome oxide, yttrium oxide, cordierite, silicon nitride, aluminum nitride, and silicon carbide.

Furthermore, according to the present invention, it is preferable that an electrode protective layer, a catalyst layer, and a catalyst protective layer are successively coated on the sensing electrode.

This arrangement is effective to sufficiently burn H₂, NOx, HC etc in the catalyst layer in any situation from the initial condition to completion of the high-temperature operation. It is also possible to adequately perform absorption and desorption of measured gas to and from the catalytic metal particles.

Accordingly, when the feedback control is performed, the response from rich to lean and the response from lean to rich can be adequately balanced. Thus, λ point can be accurately detected in the vicinity of 1.0. Therefore, it becomes possible to surely and precisely control the λ point to the theoretical air-fuel ratio. In this case, λ point is a control air-fuel ratio in the above control.

Thus, it becomes possible to provide a gas sensor whose λ point is stable in a wide temperature range regardless of operating or installed conditions.

The electrode protective layer covers the entire area of the measuring electrode. Similarly, the catalyst layer and the catalyst protective layer are provided so as to completely cover the measuring electrode when projected on the outer surface of the solid electrolytic body.

Furthermore, according to the present invention, it is preferable that the catalyst layer contains at least one catalytic metal selected from the group consisting of platinum, palladium, rhodium, and ruthenium.

These catalytic metals have excellent properties. Deviation of the λ point can be suppressed.

Furthermore, according to the present invention, it is preferable that an average particle diameter of the catalytic metal contained in the catalyst layer is in a range of 0.3 μm to 2.0 μm.

The catalytic performance of the catalytic layer can be improved. It becomes possible to suppress change of catalytic particle diameter after the heat durable operation.

When the average particle diameter is less than 0.3 μm, a reaction area becomes excessively large. Absorption and desorption of the measured gas will be done so frequently. Accordingly, the λ point may deviate. On the other hand, when the average particle diameter exceeds 2.0 μm, burning reaction of the measured gas will be insufficient. The λ point may deviate.

Furthermore, according to the present invention, it is preferable that catalytic metal contained in the catalyst layer is 10 μg/cm² to 200 μg/cm² when projected on the sensing electrode. The catalytic performance can be improved.

If the contained catalytic metal is less than 10 g/cm², the catalytic performance will be dissatisfactory. Burning of the measured gas will be insufficient.

If the catalytic metal exceeds 200 μg/cm², the reaction area of catalytic metal particles will be excessively large. Absorption and desorption of the measured gas will be done so frequently. Accordingly, the λ point may deviate.

Furthermore, it is preferable that the electrode protective layer is made of heat-resistive metal oxide containing at least one selected from the group of alumina, alumina-magnesia spinel, and zirconia.

These materials are thermally and chemically stable. The electrode protective layer will not deteriorate.

Furthermore, it is preferable that the catalyst protective layer is made of alumina or similar material.

For example, the catalyst layer is coated on the electrode protective layer by the following method.

First, solution of catalytic metal salt is impregnated in the heat-resistive ceramic particles. Then, the heat-resistive ceramic particles are dried and thermally treated at the temperature of 900° C. to 1,200° C. to let catalytic metal particles deposit on the surface of the heat-resistive ceramic particles and to let the catalytic metal particles grow.

The heat-resistive ceramic particles carrying catalytic metal particles are then kneaded with inorganic binder to form a slurry. The obtained slurry is coated on the surface of the electrode protective layer, and dried, and then sintered at the temperature of 500° C. to 1,000° C.

If the thermal treatment for the deposition and growth of catalytic metal particles is done at the temperature less than 900° C., the particle diameter will be less than 0.3 μm. The above-described effect will not be obtained satisfactorily. The λ point may deviate. If the thermal treatment temperature exceeds 1,200° C., the particle diameter will exceed 2.0 μm and the λ point may deviate.

If the sintering operation is done at the temperature less than 500° C., the bonding force between heat-resistive ceramic particles will be insufficient. The catalytic layer may peel off. If the sintering temperature exceeds 1,000° C., the specific surface area (i.e., area/weight ratio) of the heat-resistive ceramic particles will decrease and therefore catalytic performance will deteriorate.

### BRIEF DESCRIPTION OF THE DRAWINGS

The above and other objects, features and advantages of the present invention will become more apparent from the following detailed description which is to be read in conjunction with the attached drawings, in which:

FIG. 1 is a vertical cross-sectional view showing an overall arrangement of a gas sensor in accordance with a first embodiment of the present invention;

FIG. 2 is an enlarged cross-sectional view showing a distal portion of a sensing element in accordance with a first embodiment of the present invention;

FIG. 3 is a view showing a solid electrolytic body of the sensing element in accordance with the first embodiment of the present invention;

FIG. 4 is a graph showing temperature distribution of the sensing element of the first embodiment and a comparative sensing element;

FIG. 5 is a graph showing activation time of test samples in accordance with the first embodiment of the present invention;

FIG. 6 is a graph showing relationship between activation time and thickness of a protective layer in accordance with the first embodiment of the present invention;

FIG. 7A is a partly cross-sectional view showing a modified solid electrolytic body of the gas sensor in accordance with the first embodiment of the present invention;

FIG. 7B is a cross-sectional view showing details of a tapered distal portion of the solid electrolytic body shown in FIG. 7A;

FIG. 8 is a partly cross-sectional view showing another modified solid electrolytic body of the gas sensor in accordance with the first embodiment of the present invention;

FIG. 9 is an enlarged cross-sectional view showing a modified distal portion of the sensing element in accordance with the first embodiment of the present invention;

FIG. 10 is an enlarged cross-sectional view showing a distal portion of a sensing element in accordance with a second embodiment of the present invention; and

FIG. 11 is a graph showing relationship between exhaust gas temperature and control air-fuel ratio (λ) in accordance with the second embodiment of the present invention.

### DESCRIPTION OF THE PREFERRED EMBODIMENTS

Preferred embodiments of the present invention will be explained hereinafter with reference to the attached drawings. Identical parts or components are denoted by the same reference numerals throughout the views.

### First Embodiment

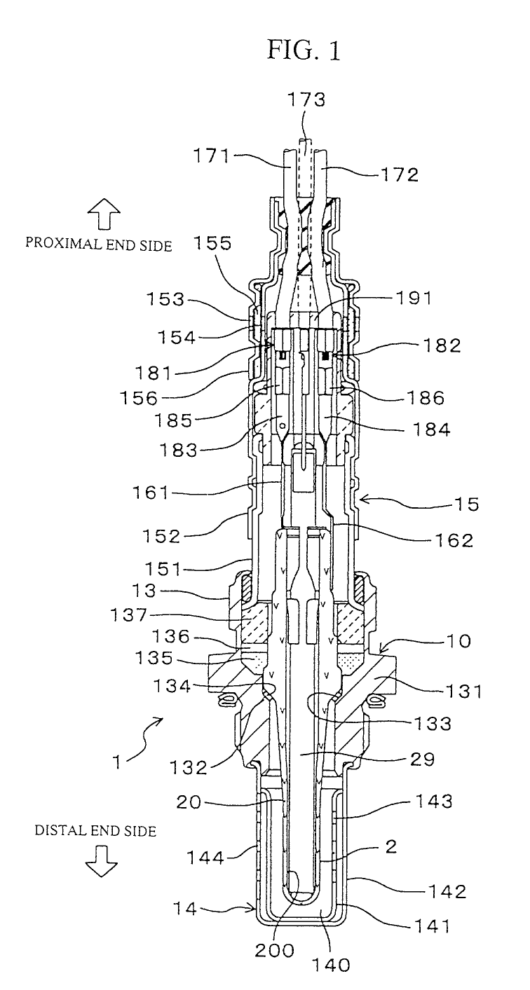

A gas sensor in accordance with a first embodiment of the present invention will be explained with reference to FIGS. 1 through 9.

As shown in FIG. 1, a gas sensor 1 of the first embodiment comprises a cup-shaped solid electrolytic body 20 having one end closed and an inside space serving as a reference gas chamber 200, a sensing electrode 22 provided on an outer surface of the solid electrolytic body 20 so as to be exposed to measured gas, a reference electrode 21 provided on an inner surface of the solid electrolytic body 20 so as to be exposed to reference gas (e.g., air) in the reference gas chamber 200, and a heater 29 disposed in the reference gas chamber 200. The heater 29 generates heat in response to electric power supplied thereto.

A leg 25 of the sensing element 2, exposed to the measured gas, consists of a proximal portion 251 and a distal portion 252. The distal portion 252 is thinner than the proximal portion 251. The heater 29 is a rod member having one end brought into contact at least partly with an inner surface 201 of the distal portion 252. The inner surface 201 defines the reference gas chamber 200.

Hereinafter, details of the gas sensor according to the first embodiment will be explained.

The gas sensor 1 of the first embodiment is installed in an exhaust system (e.g., exhaust pipe) of an automotive engine to measure the concentration of oxygen gas contained in the exhaust gas. The measured oxygen gas concentration is utilized to feedback control the air-fuel ratio of the automotive engine. In this respect, the gas sensor of this embodiment is generally referred to as an oxygen sensor.

As shown in FIG. 1, the gas sensor 1 chiefly consists of a sensing element 2 and a cylindrical housing 10. The housing 10 has an inside cylindrical hollow space for accommodating the sensing element 2. The housing 10 has a tubular portion 13. A flange 131 is integrally formed at substantially the center of an outer surface of the housing 10. A gas cover 14 is engaged with the distal end of the tubular portion 13. The gas cover 14 is placed in the exhaust pipe (not shown) so as to be exposed to exhaust gas flowing in the exhaust pipe. An air cover 15 is engaged with the proximal end of the tubular portion 13. The air cover 15 is placed in the air.

When the gas sensor 1 is installed on the exhaust pipe, the gas cover 14 is positioned in the exhaust pipe and then the flange portion 131 is tightly fixed to the exhaust pipe.

The gas cover 14 has a double-layered arrangement consisting of a stainless inner cover 141 and a stainless outer cover 142. The inner cover 141 and the outer cover 142 have through-holes 143 and 144 respectively for introducing the gas into a measured gas chamber 140.

The air cover 15 has a three-stage arrangement consisting of a protection cover 151 fixed at one end (i.e., distal end) to the tubular portion 13, a dust cover 152 overlapped at one end (i.e., distal end) with the other end (i.e., proximal end) of the protection cover 151, and a filter cover 156 overlapped at one end (i.e., distal end) with the other end (i.e., proximal end) of the dust cover 152.

The filter cover 156 and the dust cover 152 have through-holes 153 and 154 respectively for introducing air into the air cover 15. A water-repellent filter 155 is placed in an space interposed between the filter cover 156 and the dust cover 152. The water-repellent filter 151, having the capability of removing water, filters the air introduced into the air cover 15 via the through-holes 153 and 154.

The sensing element 2 is supported in the tubular portion 13 of the housing 10. Metallic holders 161 and 162, each having spring elasticity, are connected at one ends (i.e., distal ends) to the reference electrode 21 and the sensing electrode 22 respectively. The metallic holders 161 and 162 have other ends (i.e., proximal ends) 183 and 184 connected to one ends of connector terminals 181 and 182, respectively. The other ends of the connector terminals 181 and 182 are connected to lead wires 171 and 172, respectively, by calking.

The lead wires 171 and 172 are generally subjected to a tensile force acting in the axial direction of the gas sensor 1. A ceramic insulator 191, surrounding the other ends of the connector terminals 181 and 182, prevents the lead wires 171 and 172 from sliding. A lead wire 173 supplies electric power to the heater 29.

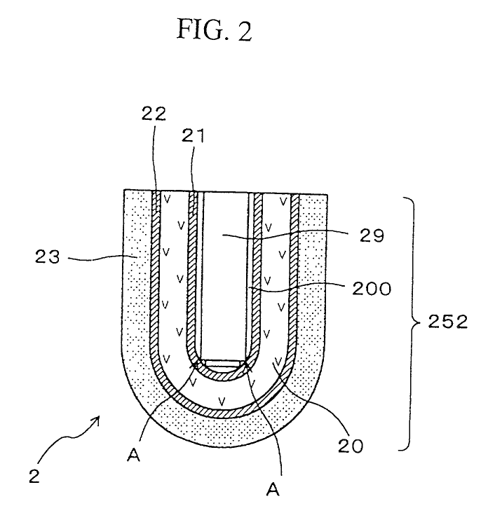

As shown in FIG. 2, the sensing element 2 of this embodiment has a cup-shaped body with one end closed and the other end opened.

The solid electrolytic body 20 of this sensing element 2 defines therein the reference gas chamber 200 which is filled with the air. The rodlike ceramic heater 29 is disposed in the reference gas chamber 200. The distal (or front) end of the heater 29 is brought into contact, along a ring or circular line “A” shown in FIG. 2, with the reference electrode 21 provided on the inside wall of the solid electrolytic body 20.

Although detailed configuration of the solid electrolytic body 20 is explained later, the leg 25 has the distal portion 252 which extends straight and is thinner than the proximal portion 251.

The sensing element 2 is disposed in the housing 10 in the following manner.

The cup-shaped solid electrolytic body 20, constituting the sensing element 2, has a flange 26 at a predetermined portion slightly offset from the axial center to the proximal end thereof. The flange 26 protrudes in the radially outward direction from the outer surface of the solid electrolytic body 20.

The housing 10 has a protruding portion 132 protruding in a radially inward direction from the inside wall thereof. The protruding portion 132 is slightly offset with respect to the flange portion 131 in the axial direction toward the distal end side.

The protruding portion 132 has a receiving surface 133 for receiving a tapered surface 260 of the flange 26 via a metallic packing 134.

As shown in FIG. 1, powder 135, a packing 136, and an insulator 137 are disposed in a closed space between a tapered surface 261 of the flange 26 and the inside surface of the housing 10. The powder 135, packing 136, and insulator 137 airtightly separate the inside space of the air cover 15 and the inside space of the gas cover 14.

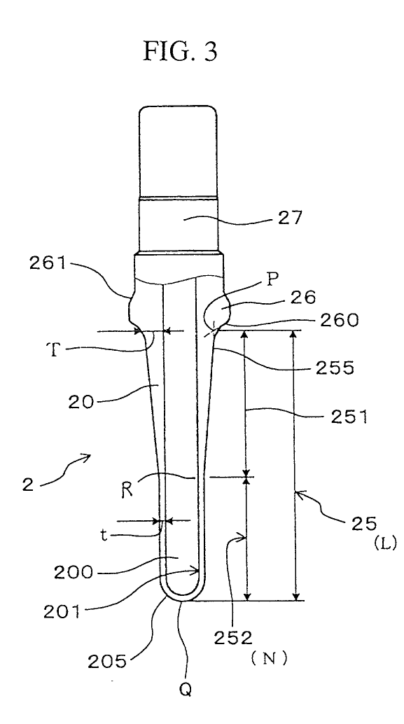

The sensing element 2, as shown in FIG. 3, comprises the flange 26 protruding outward from the outer surface thereof, a proximal end portion 27 brought into contact with and clamped by the above-described folder 162, and the leg 25 extending from the flange 26 to the distal end thereof. The leg 25 is exposed to the measured gas.

As shown in FIG. 3, a plane defined by the tapered surface 260 of the flange 26 intersects at a point “P” with a plane defined by an outer side surface 255 of the proximal portion 251 of the leg 25. The leg 25 extends from the point P (i.e., starting point) to the tip Q (i.e., end point) of the distal portion 252. The tip Q is on a bottom 205 of the distal portion 252. The length of the leg 25 is defined by the axial distance L between the points P and Q.

As shown in FIG. 3, a thickness “T” of the leg 25 is defined along a specific plane which is normal to the axis of the sensing element 2 and crosses the point P.

The leg 25 comprises the proximal portion 251 and the distal portion 252. The outer surface of the proximal portion 251 is tapered slightly. In this proximal portion 251, the diameter of solid electrolytic body 20 becomes small as it approaches the distal portion 252. The distal portion 252 is straight. The diameter of solid electrolytic body 20 is constant except for the bottom 205. The bottom 205 is configured into a semispherical shape. The distal portion 252 extends from the boundary R (i.e., starting point) between the proximal portion 251 and the distal portion 252 to the tip Q (i.e., end point) of the distal portion 252. The length of distal portion 252 is defined by a distance N between the points R and Q. The thickness of solid electrolytic body 20 is “t” in the straight region of the distal portion 252, as shown in FIG. 3.

The solid electrolytic body 20, constituting the sensing element 2, is made of oxygen ion conductive ceramic. First, ZrO2 (i.e., zirconia) and Y2O3 (i.e., yttria) are blended and milled into predetermined particle size. Then, through manufacturing steps of molding→grinding→sintering, the base material for the solid electrolytic body 20 is formed.

As shown in FIG. 2, the reference electrode 21 and the sensing electrode 22 are provided on the inner and outer surfaces of the solid electrolytic body 20 by chemical plating. A protective layer 23, which is porous and made of MgO.Al2O3 spinel, covers the sensing electrode 22 entirely.

The sensing element 2 has practical dimensions of L=27 mm, T=1.7 mm, N=10 mm, and t=0.5 mm.

The protective layer 23 has an average thickness t′=130 μm.

The position where the temperature becomes highest when electric power is supplied to the heater 29 is referred to as a heat-generating peak. According to this embodiment, the heat-generating peak appears at a predetermined point being axially offset 4.5 mm from the tip Q within the distal portion 252. An appropriate clearance, approximately 0.1 mm in average, is provided between the cylindrical surface of heater 29 and the cylindrical surface of reference electrode 21.

Temperature distribution of the heater 29, appearing when electric power is supplied to the heater 29, was measured in the following manner.

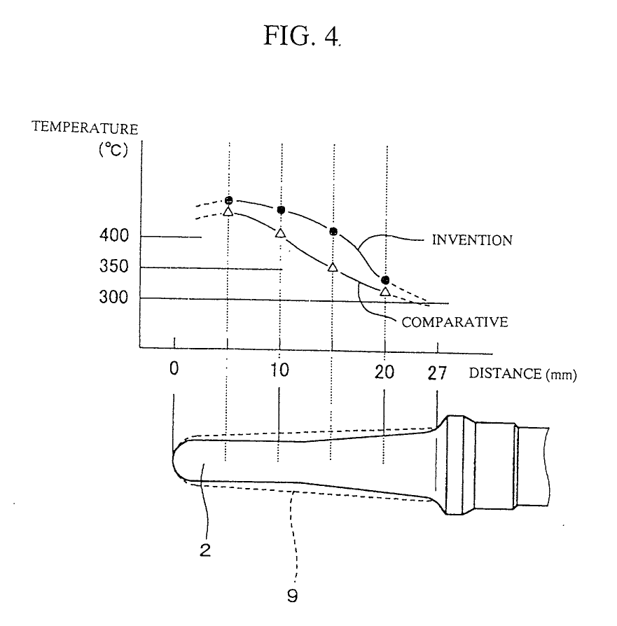

For the temperature measurement test, the sensing element 2 and the heater 29 according to this embodiment were prepared. Furthermore, another sensing element 9, having the outer shape indicated by a dotted line in FIG. 4, was prepared for comparison. As apparent from FIG. 4, the comparative sensing element 9 has a leg monotonously decreasing in diameter from proximal end to distal end. In other words, the comparative sensing element 9 differs from the inventive sensing element 2 in that there in no boundary explicitly separating the proximal portion and the distal portion. The same heater 29 is used for the comparative sensing element 9.

First, in the temperature measurement test, electric power was supplied to the heater 29 provided in each of tested sensing elements 2 and 9. After elapse of 30 seconds, the temperature was measured at several sampling points on each tested sensing element. FIG. 4 shows the measured temperature distribution thus obtained.

In FIG. 4, an abscissa represents the distance (mm) of sampling point measured from the tip of each tested sensing element, and an ordinate represents the temperature of sampling point (° C.).

As apparent from FIG. 4, the temperature of inventive sensing element 2 was higher than that of comparative sensing element 9 at all sampling points.

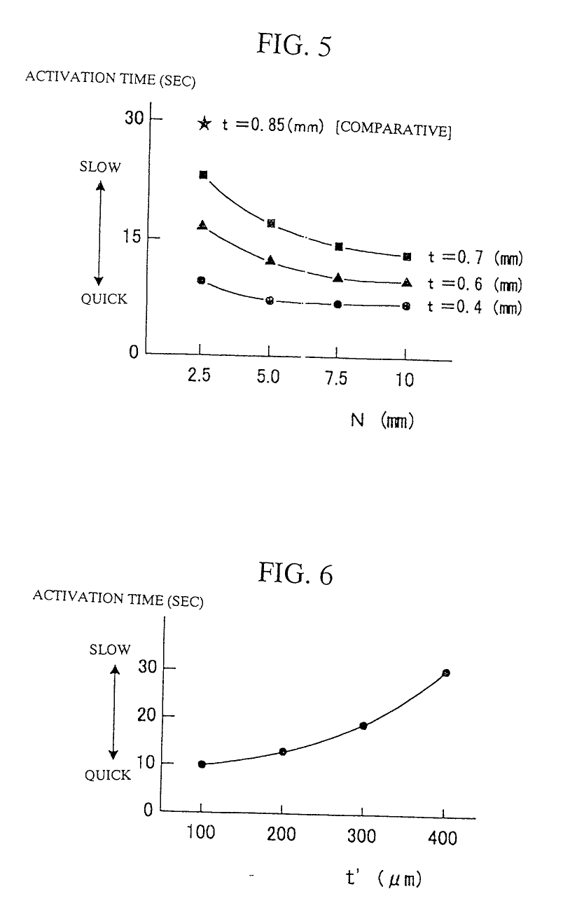

Next, influence of the thickness t(mm) and the length N (mm) of the distal portion 252 given to the activation time (sec) was checked. FIG. 5 shows the measured activation times for a total of 12 test samples of the sensing element 2 of this embodiment, which are classified into t=0.4 mm, 0.6 mm, and 0.7 mm in the thickness and also classified into N=2.5 mm, 5.0 mm, 7.5 mm, and 10 mm in the length.

FIG. 5 also shows a test result of the comparative sensing element 9 which has the thickness t=0.85 mm at a portion being axially offset by 2.5 mm from the tip.

The activation time is a time required until the sensor output reaches 0.5 V after electric power supply to the heater 29 in response to startup of the engine which installs the sensing element 2 or 9.

As understood from FIG. 5, the comparative sensing element 9 has a relatively long activation time (approximately 30 sec as indicated by a star mark). This reveals that the comparative sensing element 9 cannot accurately measure the oxygen concentration in the exhaust gas immediately after the engine has started up.

All of the test samples of the inventive sensing element 2 have activation times shorter than the activation time of the comparative sensing element 9. Especially, when the tested sensing element satisfies the relationship N≧5 mm and t≦0.7 mm, prompt activation of the sensing element is assured. In other words, the inventive sensing element 2 can be preferably used to measure the oxygen concentration in the exhaust gas immediately after the engine has started up.

Furthermore, as shown in FIG. 6, influence of the thickness t′ (μm) of protective layer 23 given to the activation time (sec) was checked. FIG. 6 shows the measured activation times for a total of four test samples of the sensing element 2 of this embodiment, which are t′=100 μm, 200 μm, 300 μm and 400 μm in the thickness. The same measuring method was used.

As understood from FIG. 6, to shorten the activation time, it is preferable that the thickness t′ of protective layer 23 is not larger than 300 μm.

The gas sensor of the present invention functions in the following manner.

The sensing element 2 of this embodiment is characterized in that the leg 25 consists of the proximal portion 251 and the distal portion 252. The distal portion 252 is thinner than the proximal portion 251.

Reducing the thickness of the distal portion 252 makes it possible to suppress heat transfer to the proximal portion 251. In other words, the sensing element 2 of this embodiment effectively reduces leakage of heat from the sensing element 2. The heat capacity of sensing element 2 can be reduced. The heater 29 can effectively warm up the sensing element 2.

The heater 29 partly contacts with a surface defining the reference gas chamber 200 (i.e., the reference electrode 21 provided on the inner surface of the solid electrolytic body 20). Heat generated from the heater 29 is directly transmitted to the solid electrolytic body 20. Thus, the gas sensor can be promptly warmed up.

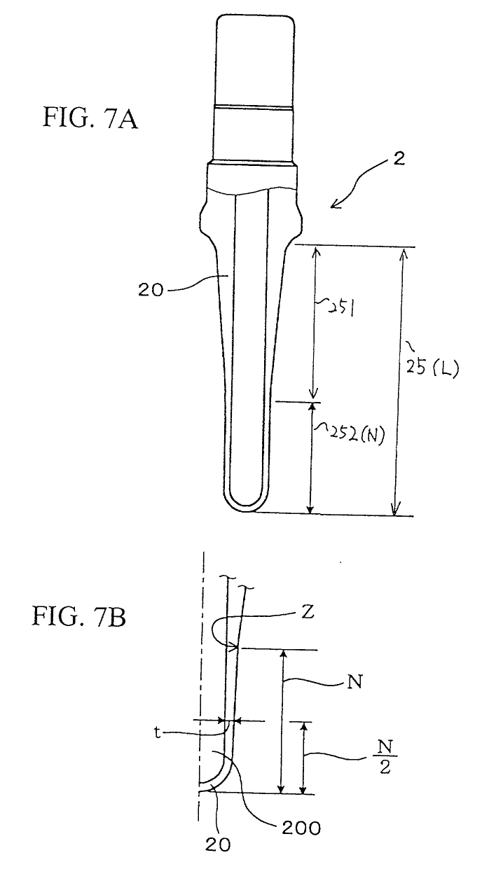

FIG. 7 shows another gas sensor in accordance with the first embodiment of the present invention.

The gas sensing element 2 shown in FIG. 7 differs from the gas sensing element 2 shown in FIG. 3 in that the distal portion 252 is slightly tapered. The gradient of the distal portion 252 is different (i.e., smaller) from that of the proximal portion 251. In other words, the tapered surface of the proximal portion 251 changes at a boundary Z to the tapered surface of the distal portion 252. In this case, as shown in FIG. 7, the thickness t of the solid electrolytic body 20 in the distal portion 252 is defined by the thickness measured at the axial center (N/2) thereof.

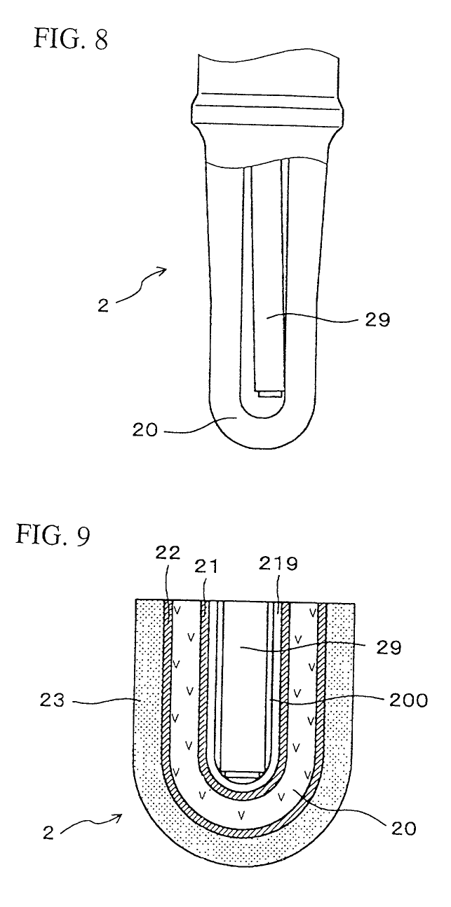

Furthermore, as shown in FIG. 8, the heater 29 can be disposed in an inclined manner with respect to the center axis of the solid electrolytic body 20. In this case, the heater 29 is brought into contact at a local small spot (not along a circular or ring line) with the solid electrolytic body 20.

Furthermore, as shown in FIG. 9, to more expedite the activation, it is preferable to provide a heat absorbing layer 219 on the surface of the reference electrode 21. The heat absorbing layer 219 is formed by coating a slurry of alumina dipping and then sintering the coated layer.

### Second Embodiment

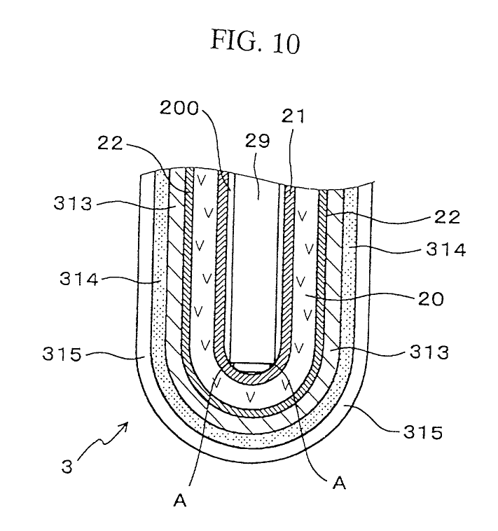

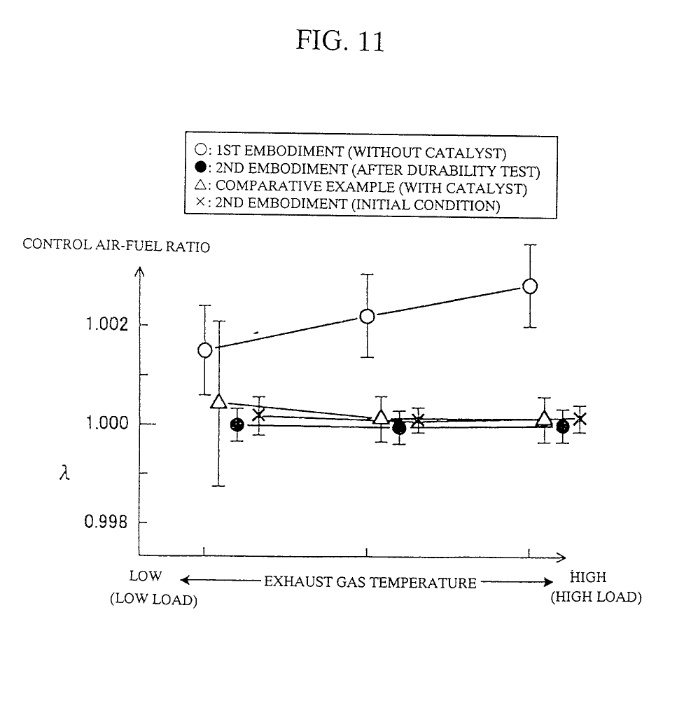

A gas sensor in accordance with a second embodiment of the present invention will be explained with reference to FIGS. 10 and 11. The gas sensor of the second embodiment is characterized in that an electrode protective layer, a catalyst layer, and a catalyst protective layer are successively coated on the sensing electrode.

As shown in FIG. 10, a sensing element 3 of the second embodiment comprises a solid electrolytic body 20 having oxygen ion conductivity, a sensing electrode 22 provided on the surface of the solid electrolytic body 20 so as to be exposed to a measured gas, and a reference electrode 21 exposed to the reference gas (i.e., air). The sensing electrode 22 is entirely covered by an electrode protective layer 313. The electrode protective layer 313 is entirely covered by a catalyst layer 314. The catalyst layer 314 is entirely covered by a catalyst protective layer 315.

The catalyst layer 314 is made of heat-resistant ceramic particles carrying catalytic metal particles on the surface thereof. An average particle diameter of the catalytic metal particles is in a range of 0.3 μm to 2.0 μm. When projected on the sensing electrode 22, the catalytic metal particles carried on the catalyst layer 314 is 10 μg/cm² to 200 μg/cm².

The gas sensor of the second embodiment is installed on an exhaust system of the automotive engine and is used as an oxygen sensor for an engine combustion control.

Furthermore, the sensing element 3 of the second embodiment comprises the electrode protective layer 313, the catalyst layer 314, and the catalyst protective layer 315 which are successively stacked on the surface of sensing electrode 22. Like the first embodiment (refer to FIG. 3), the leg of the sensing element 3 consists of the proximal portion and the distal portion. The distal portion is thinner than the proximal portion.

The sensing electrode 22 is provided on the outer surface of the solid electrolytic body 20. The reference electrode 21 is formed on the inner surface of the solid electrolytic body 20. The sensing electrode 22 and the reference electrode 21 are a pair of electrodes for detecting the concentration of oxygen gas.

The surface of the sensing electrode 22 is covered by the electrode protective layer 313. The surface of the electrode protective layer 313 is covered by the catalyst layer 314. The surface of the catalyst layer 314 is covered by the catalyst protective layer 315. Thickness of these coated layers 313 to 315 are very thin, although they are exaggeratedly shown in FIG. 10.

The solid electrolytic body 20 is made of oxygen ion conductive zirconia. The sensing electrode 22 and the reference electrode 21 are respectively formed by baking or printing a platinum film layer.

The electrode protective layer 313 is made of MgO.Al2O3 spinel. The heat-resistant ceramic particles, forming the catalyst layer 314, are preferably γ-phase Al2O3 particles with La (i.e., lanthanum) additive. The catalytic metal particles carried on the heat-resistant ceramic particles are Pt(i.e., platinum)—Rh(rhodium) particles. The catalyst protective layer 315 is made of γ-phase Al2O3 particles.

The sensing element 3 of the second embodiment is manufactured in the following manner.

First, ZrO2 is blended with 5 mol % Y2O3 and milled into predetermined particle size. Then, the blended particles are molded into a cup-shaped body as shown in FIG. 3. The molded cup-shaped body is sintered at the temperature range of 1,400° C. to 1,600° C., thereby obtaining the solid electrolytic body 20 of this embodiment.

Next, the platinum sensing electrode 22 is formed on the outer surface of the solid electrolytic body 20 by chemical plating (or evaporation).

Similarly, the platinum reference electrode 21 is formed on the inner surface of the solid electrolytic body 20 by chemical plating or the like. The platinum reference electrode 21 defines the reference gas chamber 200.

Then, MgO-Al2O3 spinel is coated on the surface of the sensing electrode 22 by plasma spray to form the electrode protective layer 313.

Then, the catalyst layer 314 is coated to cover the surface of electrode protective layer 313.

More specifically, γ-phase Al203 particles with La additive are prepared for the catalyst layer 314. The prepared γ-phase Al2O3 particles have an average particle diameter of 4 μm and a specific surface area (i.e., area/weight ratio) of 100 m²/g.

The Al2O3 particles are soaked into water solution involving Pt—Rh catalytic metal particles. The catalytic metal salt attaches on Al2O3 particles.

Thereafter, the Al2O3 particles attached with catalytic metal salt are thermally treated for one hour at 1,000° C., thereby obtaining Pt—Rh carrying γ-phase Al2O3 particles. The carried amount is 0.5 wt % in terms of solid content ratio relative to Al2O3 particles.

Alumina sol and aluminum nitrate, each serving as binder, are added to the Pt—Rh carrying γ-phase Al2O3 particles. Then, water is added as solvent to obtain a slurry. The surface of electrode protective layer 313 is coated with this slurry.

Thereafter, the coated layer is subjected to the thermal treatment at 500° C. to form catalyst layer 314. The catalyst layer 314 thus obtained has the porosity of 40% and the thickness of 60 μm.

Furthermore, to form the catalyst protective layer 315, a slurry of γ-phase Al2O3 particles similar to that for the catalyst layer 314 is prepared. This slurry is coated on the outer surface of catalyst layer 314. The coated layer is subjected to the thermal treatment to form catalyst protective layer 315. The catalyst protective layer 315 thus obtained has the porosity of 50% and the thickness of 60 μm. Thus, the sensing element 3 of the second embodiment is obtained.

The rest of sensing element 3 is structurally similar to that of the sensing element 2 of the first embodiment. The sensing element 3 is disposed in the cylindrical metal housing 10 as shown in FIG. 1.

Next, a deviation of λ (i.e., excess air ratio) point of the sensing element 3 was tested in the comparison between pre-and post-conditions of high-temperature durability test.

To conduct the high-temperature durability test, the sensing element was installed in an exhaust pipe of an automotive internal combustion engine of 3,000 cc. The automotive internal combustion engine was driven to increase the temperature of exhaust gas to a target level of 850° C. to 950° C. This condition was continuously maintained for about 1,000 hours. The tested sensing element was sufficiently exposed to heat and exhaust gas for completing the high-temperature durability test.

The measurement of λ point was conducted by feedback operating the tested sensing element at predetermined exhaust gas temperature levels of 250° C., 450° C. and 600° C. The gas concentration of the exhaust gas was measured by a gas analyzer to calculate an excess air ratio.

The above-described λ point test was also conducted for the sensing element 2 of the first embodiment as well as for the comparative sensing element 9 shown in FIG. 4 although the electrode protective layer, the catalyst layer, and the catalyst protective layer are provided on the comparative sensing element 9 for this test.

The result of λ point test is shown in FIG. 11 wherein the sensing element 3 of the second embodiment (indicated by ●) has demonstrated a preferable control air-fuel ratio (i.e., excess air ratio) λ being substantially constant (λ=1) in a wide temperature range, namely throughout the high-temperature durability test.

In other words, the second embodiment provides an excellent gas sensor whose λ point does not deviate in a wide engine operating range from a low-load condition (i.e., low exhaust gas temperature) to a high-load condition (i.e., high exhaust gas temperature).

As understood from FIG. 11, the second embodiment has excellent performance (i.e., λ=1 or stable λ point) performance compared with the sensing element 2 of the first embodiment (i.e., indicated by ∘) or the sensing element 9 of the comparative example (indicated by [symbol] ).

As understood from the foregoing, according to the sensing element of the second embodiment, it becomes possible to sufficiently burn H₂, NOx, HC etc in the catalyst layer in any situation from the initial condition to completion of the high-temperature operation. It is also possible to adequately perform absorption and desorption of measured gas to and from the catalytic metal particles.

Accordingly, when the feedback control is performed, the response from rich to lean and the response from lean to rich can be adequately balanced.

Therefore, the second embodiment makes it possible to surely and precisely control the λ point to the theoretical air-fuel ratio.

Thus, the second embodiment provides a gas sensor whose λ point is stable in a wide temperature range regardless of operating or installed conditions.

This invention may be embodied in several forms without departing from the spirit of essential characteristics thereof. The present embodiments as described are therefore intended to be only illustrative and not restrictive, since the scope of the invention is defined by the appended claims rather than by the description preceding them. All changes that fall within the metes and bounds of the claims, or equivalents of such metes and bounds, are therefore intended to be embraced by the claims.

What is claimed is:

1. A gas sensor comprising a cup-shaped solid electrolytic body with one end closed and an inside space serving as a reference gas chamber, a sensing electrode provided on an outer surface of the solid electrolytic body so as to be exposed to measured gas, a reference electrode provided on an inner surface of the solid electrolytic body so as to be exposed to reference gas in the reference gas chamber, and a heater disposed in the reference gas chamber,
wherein the solid electrolytic body has a leg to be disposed in the measured gas,
the leg comprises a proximal portion and a distal portion, the distal portion being thinner than the proximal portion, and
the heater is brought into contact with a surface defining the reference gas chamber at least partly in the region of the distal portion.

2. The gas sensor in accordance with claim 1, wherein a length N and a thickness t of the distal portion satisfy the relationship N≧5 mm and t≦0.7 mm.

3. The gas sensor in accordance with claim 1, wherein a length L and a thickness T of the leg satisfy the relationship L/T≦25 and L≧20 mm.

4. The gas sensor in accordance with claim 1, wherein the heater has a heat generating distribution having a peak temperature within a region corresponding to the distal region.

5. The gas sensor in accordance with claim 1, wherein a protective layer is provided to cover an outer surface of the sensing electrode, and a thickness of the protective layer is not larger than 300 μm.

6. The gas sensor in accordance with claim 1, wherein a heat absorbing layer is provided as a wall of the reference gas chamber at least partly in a region corresponding to the distal portion.

7. The gas sensor in accordance with claim 1, wherein an electrode protective layer, a catalyst layer, and a catalyst protective layer are successively coated on the sensing electrode.

8. The gas sensor in accordance with claim 7, wherein the catalyst layer contains at least one catalytic metal selected from the group consisting of platinum, palladium, rhodium, and ruthenium.

9. The gas sensor in accordance with claim 7, wherein an average particle diameter of the catalytic metal contained in the catalyst layer is in a range of 0.3 μm to 2.0 μm.

10. The gas sensor in accordance with claim 7, wherein catalytic metal contained in the catalyst layer is 10 μg/cm² to 200 μg/cm² when projected on the sensing electrode.
